(19) United States
(12) Patent Application Publication
(10) Pub. No.: US 2026/0092737 A1
(43) Pub. Date: Apr. 2, 2026

(54) GRAPHITE BOAT ELECTROMAGNETIC INDUCTION DRYING APPARATUS AND USE METHOD THEREOF

(71) Applicant: Suzhou HaoJian Automation System Co., Ltd., Suzhou (CN)

(72) Inventors: Yujie CHAI, Suzhou (CN); Zheng ZHANG; Shuiwei CUI, Suzhou (CN); Hui WANG, Suzhou (CN); Zhangping WU, Suzhou (CN)

(73) Assignee: Suzhou HaoJian Automation System Co., Ltd., Suzhou (CN)

(21) Appl. No.: 19/170,239

(22) Filed: Apr. 4, 2025

(30) Foreign Application Priority Data
Sep. 30, 2024 (CN) 202411386168.0

(51) Int. Cl. F26B 9/06; F26B 3/347

(52) U.S. Cl. CPC F26B 9/066; F26B 3/347

(57) ABSTRACT

The present application relates to the technical field of electromagnetic heating, and in particular relates to a graphite boat electromagnetic induction drying apparatus and a use method thereof. The graphite boat electromagnetic induction drying apparatus includes: a drying container provided with an upper cover plate and an accommodation space; and a lower heating assembly arranged in the accommodation space, the lower heating assembly is adapted for placing a graphite boat to be dried thereon, and the lower heating assembly includes an electromagnetic heating coil configured to generate a high-frequency electromagnetic field to induce thermal energy in the graphite boat to be dried. The present application solves the problem of low drying efficiency caused in a case that the electric heating rings and electric heating sheets can only generate heat in a certain area and the graphite boats outside the area need to be dried by the heat in the air flow.

### TECHNICAL FIELD

The present application relates to the technical field of electromagnetic heating, and in particular relates to a graphite boat electromagnetic induction drying apparatus and a use method thereof.

### BACKGROUND OF THE INVENTION

As a key process in the manufacturing process of photovoltaic cells, graphite boat drying mainly involves drying by an important tool graphite boat in the manufacturing process of cells. Through the drying technology, moisture and other residues on the surface and in the interior of the graphite boat can be effectively removed, thereby improving the quality and performance of photovoltaic cells. The basic principle of graphite boat drying is to make the moisture and other volatile substances inside the graphite boat evaporate through the heat transfer effect, so as to achieve the purpose of removing impurities and improving the quality of graphite boats.

As to the existing graphite boat drying, electric heating sheets and electric heating rings are generally used for heating. In the above method, the electric heating rings and electric heating sheets can only generate heat in a certain area, causing that the graphite boats outside the area need to be dried by the heat in the air flow, and the drying efficiency is low.

### SUMMARY OF THE INVENTION

In view of this, the present application provides a graphite boat electromagnetic induction drying apparatus, aiming to solve the problem of low drying efficiency caused in a case that the electric heating rings and electric heating sheets can only generate heat in a certain area and the graphite boats outside the area need to dried by the heat in the air flow.

In a first aspect, the present application provides a graphite boat electromagnetic induction drying apparatus, including: a drying container provided with an upper cover plate and an accommodation space; and a lower heating assembly arranged in the accommodation space, where the lower heating assembly is adapted for placing a graphite boat to be dried thereon, and the lower heating assembly includes an electromagnetic heating coil configured to generate a high-frequency electromagnetic field to induce thermal energy in the graphite boat to be dried.

As to the electromagnetic coil heating mode, when a high-frequency high-voltage current that varies at high speed flows through the coil, an alternating magnetic field that varies at high speed will be generated. When a graphite boat is placed on the alternating magnetic field, the surface of the graphite boat will cut through alternating magnetic field lines to generate an alternating current (i.e., an eddy current) at the bottom of the graphite boat. The eddy current makes carriers at the bottom of the graphite boat move irregularly at high speed, and the carriers collide with and rub against each other to generate a thermal energy, thereby heating substances. Compared with electric heating rings and electric heating sheets which can only heat a certain area, the electromagnetic field generated by an electromagnetic heating coil has a larger range, such that the entire graphite boat is located within the range of the electromagnetic field, and has advantages of high heating efficiency and uniform drying.

In an optional embodiment, the lower heating assembly includes a first supporting plate and a second supporting plate, and the electromagnetic heating coil is arranged between the first supporting plate and the second supporting plate. The specific structure of the lower heating assembly is arranged such that the electromagnetic heating coil is placed between the two supporting plates, and the first supporting plate and the second supporting plate play a role of protecting the electromagnetic heating coil.

In an optional embodiment, the electromagnetic heating coil is formed by nesting electromagnetic heating wire rings in circles, with the electromagnetic heating wire rings extending in circles from an innermost layer to a periphery thereof, and adjacent electromagnetic heating wire rings are connected end to end and arranged to abut against each other.

In an optional embodiment, the spaced graphite plates may evaporate the moisture within the graphite boat from the gap, and furthermore, the length direction of each of the graphite plates is the same as the length direction of the longitudinal section, and the magnetic field lines generated in the longitudinal section are vertical to the graphite plate, to heat at a highest efficiency.

In an optional embodiment, the drying container is provided with an upper cover plate and a bottom plate, where the bottom plate is connected to the second supporting plate through a supporting rib plate, two ends of the lower heating assembly are each provided with a supporting end adapted for supporting the graphite boat to be dried, and the upper cover plate is arranged opposite to the bottom plate.

In an optional embodiment, a temperature sensor is further included, where the temperature sensor is arranged on an inner side wall of the accommodation space, the bottom plate is connected with a heat dissipation pipe, and a suction fan is arranged on an end, facing away from the bottom plate, of the heat dissipation pipe.

In an optional embodiment, two lower heating assemblies are provided, and the first supporting plate of each of the lower heating assemblies is separately adapted for placing a graphite boat to be dried thereon.

In an optional embodiment, an outer frame, an exhaust fan and an air blower are further included, where the drying container is placed on and fixedly connected to the outer frame, and the exhaust fan and the air blower are connected to the drying container through pipelines, respectively.

In an optional embodiment, an upper heating assembly is further included, where the upper heating assembly is arranged over the graphite boat to be dried, and the graphite boat to be dried is configured to be accommodated between the upper heating assembly and the lower heating assembly.

In a second aspect, the present application further provides a method for using the graphite boat electromagnetic induction drying apparatus, where the method includes: using the electromagnetic heating coil in an energized state to induce thermal energy that dries the graphite boat to be dried.

### BRIEF DESCRIPTION OF THE FIGURES

In order to more clearly illustrate the technical solutions in specific embodiments of the present application or in the prior art, the accompanying drawings to be used in the description of the specific embodiments or the prior art will be briefly introduced below, and apparently, the accompanying drawings in the following description are some of the embodiments of the present application, and for those skilled in the art, other drawings can be further obtained according to these drawings without any creative effort.

FIG. 1 is a top view of a graphite boat electromagnetic induction drying apparatus according to an embodiment of the present application;

FIG. 2 is a front view of a graphite boat electromagnetic induction drying apparatus according to an embodiment of the present application;

FIG. 3 is a half-sectional view of a graphite boat placed in a drying container according to an embodiment of the present application;

FIG. 4 is a schematic view of the interior of a drying container according to an embodiment of the present application;

FIG. 5 is a schematic diagram of a graphite boat and a supporting end according to an embodiment of the present application;

FIG. 6 is a sectional view of a lower heating assembly according to an embodiment of the present application;

FIG. 7 is a schematic diagram showing two electromagnetic heating coils of a lower heating assembly being connected in series according to an embodiment of the present application;

FIG. 8 is a schematic diagram of an electromagnetic heating coil of a lower heating assembly according to an embodiment of the present application.

Reference numerals: 1, drying container; 101, upper cover plate; 102, side plate; 103, bottom plate; 104, accommodation space; 105, supporting end; 1051, protrusion; 106, supporting rib plate; 107, non-contact infrared thermometer; 2, air blower; 3, air filter; 4, exhaust fan; 5, outer frame; 6, graphite boat to be dried; 601, graphite plate; 7, heat dissipation pipe; 701, suction fan; 8, lower heating assembly; 801, first supporting plate; 802, second supporting plate; 803, electromagnetic heating coil; 8031, transverse section; 8032, longitudinal section.

### DETAILED DESCRIPTION OF THE INVENTION

In order to make the objects, technical solutions and advantages of the embodiments of the present application clearer, the technical solutions in the embodiments of the present application will be described clearly and completely below in combination with the accompanying drawings in the embodiments of the present application, and apparently, the described embodiments are a part but not all of the embodiments of the present application. Based on the embodiments in the present application, all the other embodiments obtained by those skilled in the art without any creative effort shall all fall within the scope of protection of the present application.

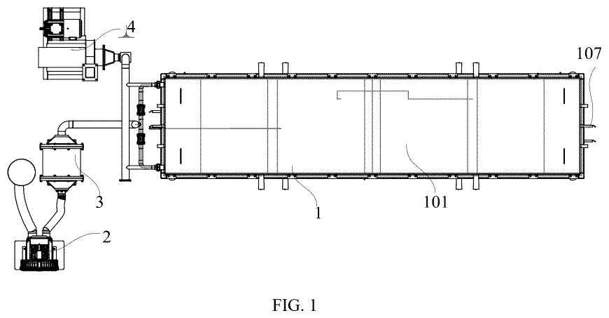

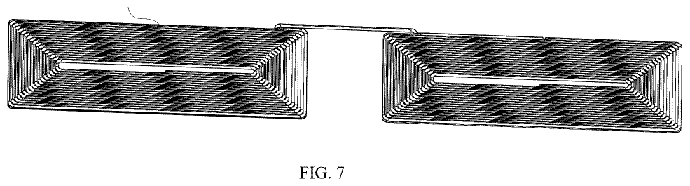

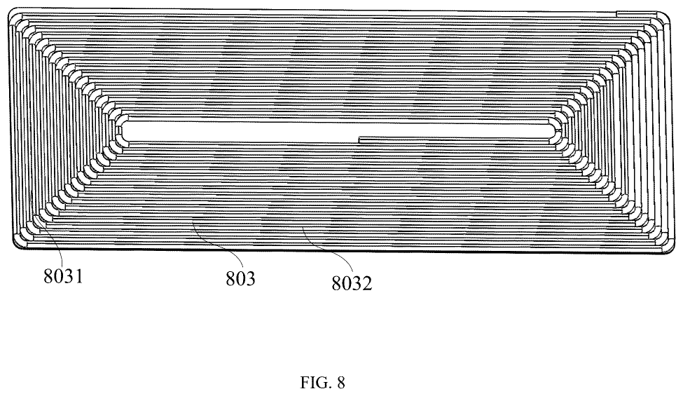

Embodiments of the present application are described below in combination with FIG. 1 to FIG. 8.

According to embodiments of the present application, on the one hand, a graphite boat electromagnetic induction drying apparatus is provided, including: a drying container 1 provided with an accommodation space 104; and
a lower heating assembly 8 arranged in the accommodation space 104, where the lower heating assembly 8 is adapted for placing a graphite boat to be dried 6 thereon, and the lower heating assembly 8 includes an electromagnetic heating coil 803 configured to generate a high-frequency electromagnetic field to induce thermal energy in the graphite boat to be dried 6.

In this embodiment, as to the electromagnetic coil heating mode, when a high-frequency high-voltage current that varies at high speed flows through the coil, an alternating magnetic field that varies at high speed will be generated. When a graphite boat is placed on the alternating magnetic field, the surface of the graphite boat will cut through alternating magnetic field lines to generate an alternating current (i.e., an eddy current) at the bottom of the graphite boat. The eddy current makes carriers at the bottom of the graphite boat move irregularly at high speed, and the carriers collide with and rub against each other to generate a thermal energy, thereby heating substances. Compared with electric heating rings and electric heating sheets which can only heat a certain area, the electromagnetic field generated by the electromagnetic heating coil 803 has a larger range, such that the entire graphite boat is located within the range of the electromagnetic field, and has advantages of high heating efficiency and uniform drying.

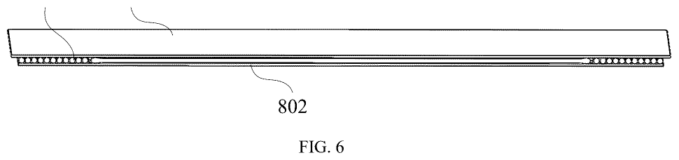

As shown in FIG. 6, in an embodiment, the lower heating assembly 8 includes a first supporting plate 801 and a second supporting plate 802, and the electromagnetic heating coil 803 is arranged between the first supporting plate 801 and the second supporting plate 802.

In this embodiment, the specific structure of the lower heating assembly 8 is arranged such that the electromagnetic heating coil 803 is placed between two supporting plates, the first supporting plate 801 and the second supporting plate 802 play a role of protecting the electromagnetic heating coil 803. It should be noted that the first supporting plate 801 and the second supporting plate 802 are respectively fixedly connected to the electromagnetic heating coil 803, and fixing may be achieved in a variety of ways such as gluing and snap-fitting, and will not be limited herein.

As shown in FIGS. 6, 7, and 8, in an embodiment, the electromagnetic heating coil 803 is formed by nesting electromagnetic heating wire rings in circles, with the electromagnetic heating wire rings extending in circles from an innermost layer to a periphery thereof, and adjacent electromagnetic heating wire rings are connected end to end and arranged to abut against each other.

In this embodiment, the electromagnetic heating wire rings are connected end to end, such that the entire electromagnetic heating coil 803 is composed of a single wire, thereby avoiding different wires from generating a disordered heating magnetic field. In addition, the electromagnetic heating coil 803 is formed by nesting electromagnetic heating wire rings in circles, with the electromagnetic heating wire rings extending in circles from an innermost layer to the periphery thereof, and adjacent electromagnetic heating wire rings are arranged to abut against each other, to accommodate the maximum number of circles in the smallest possible plane. In addition, the electromagnetic heating coil 803 is not disconnected in the middle and is connected in series, and disconnection may lead to a risk of heating, and if it is connected in parallel, the loss will increase, causing poor heating effect of an individual coil, since the magnetic field will become low and the heating effect on graphite will be poor.

As shown in FIGS. 6, 7, and 8, in an embodiment, each of the electromagnetic heating wire rings has a rectangular shape and is provided with a transverse section 8031 and a longitudinal section 8032, the graphite boat to be dried 6 is provided with at least two graphite plates 601 spaced apart from each other, and a length direction of each of the graphite plates 601 is the same as a length direction of the longitudinal section 8032.

In this embodiment, as to the electromagnetic coil heating mode, when a high-frequency high-voltage current that varies at high speed flows through the coil, an alternating magnetic field that varies at high speed will be generated. When a graphite boat is placed on the alternating magnetic field, the surface of the graphite boat will cut through alternating magnetic field lines to generate an alternating current (i.e., an eddy current) at the bottom of the graphite boat. The eddy current makes carriers at the bottom of the graphite boat move irregularly at high speed, and the carriers collide with and rub against each other to generate a thermal energy, thereby heating substances. The spaced graphite plates 601 evaporate the moisture within the graphite boat from the gap, and furthermore, the length direction of each of the graphite plates 601 is the same as the length direction of the longitudinal section 8032, the magnetic field lines generated in the longitudinal section 8032 are vertical to the graphite plate 601, to heat at a highest efficiency. It should be noted that, the length of the longitudinal section 8032 is greater than the length of the transverse section 8031.

As shown in FIGS. 1, 3, 4, and 5, in an embodiment, the drying container 1 is provided with an upper cover plate 101 and a bottom plate 103, where the bottom plate 103 is connected to the second supporting plate 802 through a supporting rib plate 106, two ends of the lower heating assembly 8 are each provided with a supporting end 105 adapted for supporting the graphite boat to be dried 6, and the upper cover plate 101 is arranged opposite to the bottom plate 103.

In this embodiment, the upper cover plate 101 is arranged opposite to the bottom plate 103 to enclose the accommodation space 104 and accelerate the drying speed of the graphite boat to be dried 6. In addition, the two ends of the lower heating assembly 8 are each provided with a supporting end 105 adapted for supporting the graphite boat to be dried 6, so as to avoid the lower heating assembly 8 from bearing the gravity of the graphite boat to be dried 6, and the bottom plate 103 is connected to the second supporting plate 802 through a supporting rib plate 106 configured to support the second supporting plate 802.

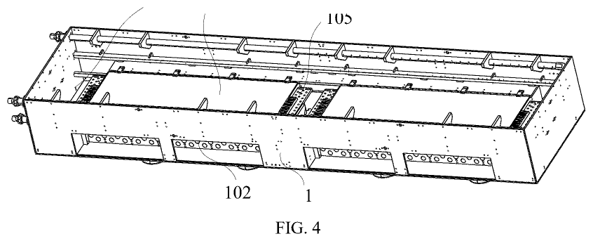

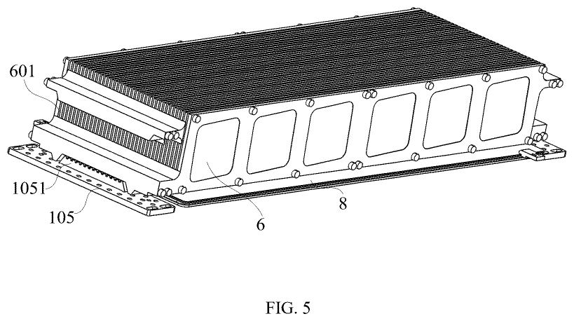

As shown in FIG. 5, in an embodiment, each supporting end 105 is provided with a protrusion 1051 which fits with the bottom of the graphite boat to be dried 6 and restricts the free movement of the graphite boat to be dried 6. As shown in FIG. 4, the drying container 1 further includes a side plate 102, where the side plate 102, the bottom plate 103, and the upper cover plate 101 form an accommodation space 104, and the side plate 102 is provided with a number of heat dissipation holes for exchanging air flow between the accommodation space 104 and external air. It should be noted that a sufficient distance is reserved between the side surface of the lower heating assembly 8 and the side plate 102, so as to facilitate circulation of the gas within the accommodation space 104 on the one hand, and to avoid the thermal energy generated in the graphite boat to be dried 6 from affecting the side plate 102 and the bottom plate 103 on the other hand.

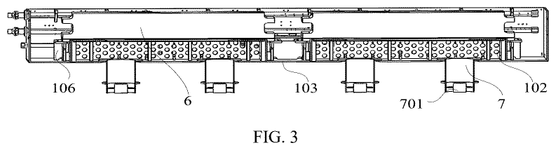

As shown in FIG. 3, in an embodiment, a temperature sensor is also included, the temperature sensor is arranged on the inner side wall of the accommodation space 104, the bottom plate 103 is connected with a heat dissipation pipe 7, and a suction fan 701 is arranged on an end, facing away from the bottom plate 103, of the heat dissipation pipe 7. It should be noted that the first temperature sensor is arranged on the upper surface of the first supporting plate 801, the inner side wall of the accommodation space 104 is provided with a second temperature sensor towards the graphite boat to be dried 6, and the upper cover plate 101 is provided with a third temperature sensor towards the graphite boat to be dried 6. In addition, as shown in FIG. 1, a non-contact infrared thermometer 107 is also arranged on the side wall of the drying container 1, and the non-contact infrared thermometer 107 is arranged at two ends of the graphite plate 601 to sense temperature changes within the graphite boat to be dried 6.

In this embodiment, the temperature sensor is configured to sense the temperature within the accommodation space 104, the heat dissipation pipe 7 is configured to further enhance the ability to dissipate heat within the accommodation space 104, the suction fan 701 is configured to extract air from the interior to the exterior, and the suction fan 701 is configured to dissipate heat from the electromagnetic heating coil 803 to prevent the coil from overheating.

As shown in FIG. 3 and FIG. 4, in an embodiment, two lower heating assemblies 8 are provided, and the first supporting plate 801 of each of the lower heating assemblies 8 is separately adapted for placing a graphite boat to be dried thereon. Two lower heating assemblies 8 are arranged to enhance the drying efficiency of the entire drying container 1, i.e., the drying container 1 can simultaneously dry two graphite boats to be dried 6. It should be noted that the electromagnetic heating coils 803 of adjacent lower heating assemblies 8 are connected in series, and all the electromagnetic heating coils 803 of the lower heating assemblies 8 are coiled by a single wire.

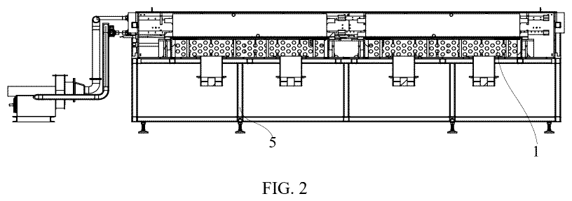

As shown in FIG. 1 and FIG. 2, in an embodiment, an outer frame 5, an exhaust fan 4 and an air blower 2 are further included, the drying container 1 is placed on and fixedly connected to the outer frame 5, and the exhaust fan 4 and the air blower 2 are connected to the drying container 1 through pipelines, respectively.

In this embodiment, the outer frame 5 is configured to fix and support the drying container 1. During heating, the exhaust fan 4 and the air blower 2 operate together, i.e., the exhaust fan 4 extracts the air inside the accommodation space 104, and the air blower 2 blows the external air in to realize circulation of the gas inside the drying container 1. As shown in FIG. 1, an air filter 3 is also arranged between the air blower 2 and the drying container 1, where the air filter 3 filters the gas blown in by the air blower 2 to ensure the purity of the gas inside the drying container 1.

In an embodiment, an upper heating assembly is also included, the upper heating assembly is arranged over the graphite boat to be dried 6, and the graphite boat to be dried 6 is configured to be accommodated between the upper heating assembly and the lower heating assembly 8. The heating efficiency is further enhanced through cooperation between the upper heating assembly and the lower heating assembly 8. It should be noted that specific structures of the upper heating assembly and the lower heating assembly 8 are identical.

For automatic control, a power supply, a display screen and a controller are also included, where the power supply is connected to the electromagnetic heating coil 803, and the controller is respectively connected to the exhaust fan 4, the air blower 2, the suction fan 701, the temperature sensor, the power supply, and the display screen, and the display screen displays the specific temperature.

According to embodiments of the present application, on the other hand, a method for using the graphite boat electromagnetic induction drying apparatus is further provided, and the method includes the following steps:
1) placing the graphite boat to be dried 6 on the supporting end 105 with the aid of an auxiliary mechanical arm, and closing the upper cover plate 101 to enclose the accommodation space 104;
(2) energizing the power supply such that the electromagnetic heating coil 803 enables the graphite boat to be dried 6 to generate a thermal energy by itself through a high-frequency conversion magnetic field, and the first temperature sensor, the second temperature sensor and the third temperature sensor transmit the temperature information to the controller in real time, and the temperature value is shown on the display screen until the temperature in the accommodation space 104 reaches about 200° C., and heating is maintained for about ten minutes, and then heating is stopped; and at the same time a non-contact infrared thermometer 107 is also arranged to monitor the heating temperatures of different areas of the graphite boat to be dried 6 in real time, and to monitor whether each area is uniformly heated; and
(3) after stopping heating, turning on the suction fan 701, the air blower 2 and the exhaust fan 4, the wind from the air blower 2 enters the drying container 1 through the air filter 3, forming a pattern in which the air blower 2 blows air inwards and the suction fan 701 and the exhaust fan 4 discharge air outwards, thereby accelerating gas flow in the drying container 1, and reducing the overall temperature of the graphite boat as quickly as possible.

The graphite boat electromagnetic induction drying apparatus provided in the present application has the following advantages: (1) an electromagnetic heating coil 803 is formed by setting up a single wire to avoid generating a disordered electromagnetic field; (2) the length direction of the graphite plate 601 of the graphite boat is arranged to be consistent with the length direction of the longitudinal section 8032 to achieve a maximum heating efficiency.

As an alternative embodiment, one, three, four or even more lower heating assemblies 8 may also be arranged in the drying container 1.

As an alternative embodiment, the upper heating assembly may also not be arranged.

Although embodiments of the present application are described in combination with the accompanying drawings, however, various modifications and variations may be made by those skilled in the art without departing from the spirit and scope of the present application, and such modifications and variations all fall within the scope defined by the appended claims.

1. A graphite boat electromagnetic induction drying apparatus, comprising:
a drying container (1) provided with an accommodation space (104); and
a lower heating assembly (8) arranged in the accommodation space (104), wherein the lower heating assembly (8) is adapted for placing a graphite boat to be dried (6) thereon, and the lower heating assembly (8) comprises an electromagnetic heating coil (803) configured to generate a high-frequency electromagnetic field to induce thermal energy in the graphite boat to be dried (6).

2. The graphite boat electromagnetic induction drying apparatus according to claim 1, wherein the lower heating assembly (8) comprises a first supporting plate (801) and a second supporting plate (802), and the electromagnetic heating coil (803) is arranged between the first supporting plate (801) and the second supporting plate (802).

3. The graphite boat electromagnetic induction drying apparatus according to claim 1, wherein the electromagnetic heating coil (803) is formed by nesting electromagnetic heating wire rings in circles, with the electromagnetic heating wire rings extending in circles from an innermost layer to a periphery thereof, and adjacent electromagnetic heating wire rings are connected end to end and arranged to abut against each other.

4. The graphite boat electromagnetic induction drying apparatus according to claim 3, wherein each of the electromagnetic heating wire rings has a rectangular shape and is provided with a transverse section (8031) and a longitudinal section (8032), the graphite boat to be dried (6) is provided with at least two graphite plates (601) spaced apart from each other, and a length direction of each of the graphite plates (601) is the same as a length direction of the longitudinal section (8032).

5. The graphite boat electromagnetic induction drying apparatus according to claim 2, wherein the drying container (1) is provided with an upper cover plate (101) and a bottom plate (103), the bottom plate (103) is connected to the second supporting plate (802) through a supporting rib plate (106), two ends of the lower heating assembly (8) are each provided with a supporting end (105) adapted for supporting the graphite boat to be dried (6), and the upper cover plate (101) is arranged opposite to the bottom plate (103).

6. The graphite boat electromagnetic induction drying apparatus according to claim 5, further comprising a temperature sensor arranged on an inner side wall of the accommodation space (104), the bottom plate (103) is connected with a heat dissipation pipe (7), and a suction fan (701) is arranged on an end, facing away from the bottom plate (103), of the heat dissipation pipe (7).

7. The graphite boat electromagnetic induction drying apparatus according to claim 2, wherein two lower beating assemblies (8) are provided, and the first supporting plate (801) of each of the lower heating assemblies (8) is separately adapted for placing a graphite boat to be dried thereon.

8. The graphite boat electromagnetic induction drying apparatus according to claim 1, further comprising an outer frame (5), an exhaust fan (4) and an air blower (2), the drying container (1) is placed on and fixedly connected to the outer frame(S), and the exhaust fan (4) and the air blower (2) are connected to the drying container (1) through pipelines, respectively.

9. The graphite boat electromagnetic induction drying apparatus according to claim 1, further comprising an upper heating assembly arranged over the graphite boat to be dried (6), the graphite boat to be dried (6) is configured to be accommodated between the upper heating assembly and the lower heating assembly (8).

10. A method for using the graphite boat electromagnetic induction drying apparatus according to claim 1, comprising: using the electromagnetic heating coil (803) in an energized state to induce thermal energy that dries the graphite boat to be dried (6).
